(19) United States
(12) Patent Application Publication
(10) Pub. No.: US 2012/0211999 A1
(43) Pub. Date: Aug. 23, 2012

(54) Keyless Lock for Doors

(76) Inventor: Robert W. VanHellemont, Walled Lake, MI (US)

(21) Appl. No.: 13/450,661

(22) Filed: Apr. 19, 2012

Related U.S. Application Data
(63) Continuation of application No. 12/975,544, filed on Dec. 22, 2010.
Application No. 12/975,544 is a continuation of application No. 12/489,036, filed on Jun. 22, 2009, now abandoned.
Application No. 12/489,036 is a continuation of application No. 11/158,608, filed on Jun. 22, 2005, now abandoned.

(51) Int. Cl. E05C 5/04; E05C 19/12; E05B 15/00

(52) U.S. Cl. 292/58; 292/336.3; 292/96

(57) ABSTRACT

A keyless door lock that prevents young children from opening doors. The lock is a bolting mechanism type lock or a latching type lock having no keyed lock access side to it, but rather, a means for locking and unlocking the lock, such as a knob, on one or both sides of the door that when turned, unlocks the door. The lock is positioned within the door at a height that is unreachable by small children. The lock can lock doors internal to the home (e.g., doors to medicine closets, cleaning supply closets, garage doors, doors at the top of stairs) and doors that provide access to the exterior of the home, thus access to leave the home without supervision. Adults and older children, however, are never locked in or out of the room or house as merely the turning of a knob is required for operating the lock.

### CROSS-REFERENCE TO RELATED APPLICATIONS

The present application is a continuation of U.S. patent application Ser. No. 12/975,544 filed on Dec. 22, 2010, which is a continuation of U.S. patent application Ser. no. 12/489,036 filed on Jun. 22, 2009, which is a continuation of U.S. patent application Ser. no. 11/158,608 filed on Jun. 22, 2005, all of which are incorporated in their entirety herein by reference.

### FIELD OF THE INVENTION

The invention relates generally to the fields of mechanical engineering and child safety. More particularly, the invention relates to a keyless lock for doors.

### BACKGROUND

All too often parents have discovered that their small children are able to unlock and open a door to the outside of the home or a door at the top of a stairway. To avoid devastating accidents that can occur when children open doors that are not to be opened by them, parents have resorted to installing a lock on the inside surface of the door that requires the use of a key to unlock and open the door. This presents a significant inconvenience to everyone in the home who uses the door, as the key to the lock can be easily misplaced. Such a lock also presents a safety hazard in the case of fire, for example, when the lock key is not readily available and the occupants of the home, possibly panicked, are obstructed or prevented from exiting the home. A need exists for a door lock that allows adults and older children to easily operate the lock while precluding small children from doing so.

### SUMMARY OF THE INVENTION

What has been developed is a keyless lock for doors that prevents young children from opening doors their parents or caretakers do not wish them to open. An exemplary keyless lock of the invention is a dead-bolt type lock having no keyed lock access side to it, but rather, a knob or handle on one or both sides of the door that when turned, locks or unlocks the door. The lock is positioned within the door at a height that is unreachable by small children (e.g., at least about 1.5 meters). The keyless lock can be used to lock hinged and sliding doors. The lock is compatible for doors for interior rooms of a home as well as for doors that provide access to the exterior of the home and therefore access for small children to leave the premises of the home without supervision. Adults and older children, however, are not locked in or out of the room or house as no key is required for operating the lock, merely the turning of a knob.

Accordingly, the invention features a door having a keyless lock. This keyless lock includes a first means for locking and unlocking the lock and a second means for locking and unlocking the lock, the first means positioned on the interior surface of the door and the second means positioned on the exterior surface of the door. The first and second means are positioned on the door at a distance from the bottom of the door of at least about 1.5 meters. The first and second means for locking and unlocking the lock can include a knob and a handle. The door can be a hinged door as well as a sliding door.

In another aspect, the invention features a kit for locking a door. This kit includes (a) a keyless lock including a first means for locking and unlocking the door and a second means for locking and unlocking the lock that when installed in the door, the first means is positioned on the interior surface of the door and the second means is positioned on the exterior surface of the door, and (b) printed instructions for installing the keyless lock in the door at a distance from the bottom of the door of at least about 1.5 meters. The first and second means for locking and unlocking the lock can include a knob and a handle. The door can be a hinged door as well as a sliding door.

Also within the invention is a method for locking a door. This method includes the steps of: (a) providing a door, (b) providing a keyless lock installed within the door, the keyless lock including a first means for locking and unlocking the lock and a second means for locking and unlocking the lock, the first means positioned on the interior surface of the door and the second means positioned on the exterior surface of the door, and (c) manipulating the first or the second means for locking and unlocking the lock. The first and second means for locking and unlocking the lock can include a knob and a handle. The door can be a hinged door as well as a sliding door.

Unless otherwise defined, all technical terms used herein have the same meaning as commonly understood by one of ordinary skill in the art to which this invention belongs. Although systems, materials and devices similar or equivalent to those described herein can be used in the practice or testing of the present invention, suitable systems, materials, and devices are described below. All publications, patent applications, patents and other references mentioned herein are incorporated by reference in their entirety. In case of conflict, the present specification, including definitions, will control. In addition, the systems, materials, and devices are illustrative only and not intended to be limiting. Other features and advantages of the invention will be apparent from the following detailed description, and from the claims.

### BRIEF DESCRIPTION OF THE DRAWINGS

FIG. 1 is a perspective front view of a door having a keyless lock of the invention.

FIG. 2 is an exploded view of a first embodiment of a keyless lock.

FIG. 3 is a cross-sectional view of the embodiment of FIG. 2, the lock being in an unlocked position.

FIG. 4 is a cross-sectional view of the embodiment of FIG. 2, the lock being in a locked position.

FIG. 5 is an exploded view of a second embodiment of a keyless lock.

FIG. 6 is a front view of the keyless lock of FIG. 5 in a locked position.

FIG. 7 is a front view of the keyless lock of FIG. 5 in an unlocked position.

FIG. 8 is a perspective view of a sliding door having the keyless lock of FIGS. 5-7 mounted thereon.

FIG. 9 is a perspective front view of a third embodiment of a keyless lock.

FIG. 10 is a perspective view of a sliding door having the keyless lock of FIG. 9 mounted thereon.

### DETAILED DESCRIPTION

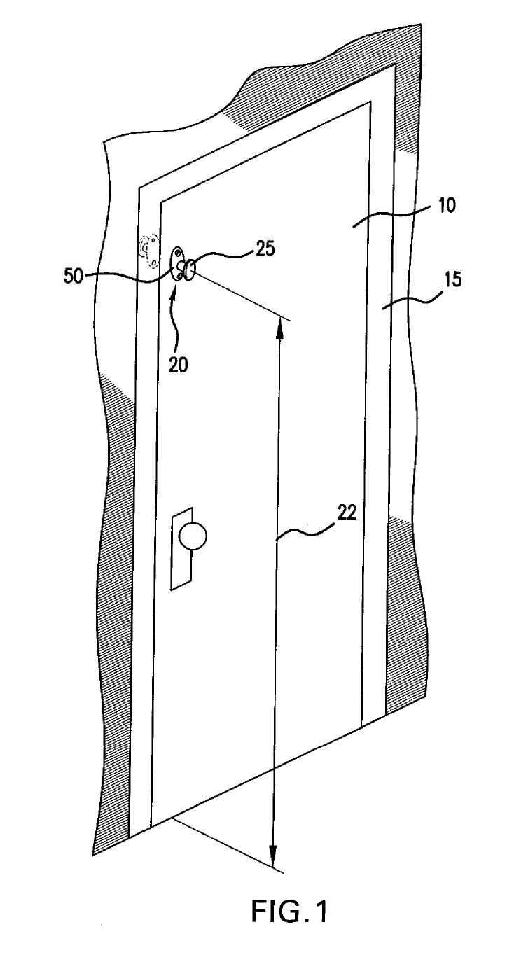

In brief overview, referring to FIG. 1, a first exemplary embodiment of a keyless door lock 20 is shown mounted in a hinged door 10. An operator locks and unlocks the door by manipulating a means for locking and unlocking the lock. The means for locking and unlocking the lock can be any graspable implement, such as a handle or a knob. In the embodiment shown in FIGS. 1-10, the means for locking and unlocking the lock is knob 25, and to lock and unlock the door, one simply grasps the knob 25 and turns it in the appropriate direction. The lock 20 can include one means for locking and unlocking the lock (e.g., knob 25) mounted to one side of the door 10, but preferably includes a first and a second means for unlocking the lock (e.g., two knobs 25), the first means mounted to the interior surface of the door and the second means mounted to the exterior surface of the door 10. Having first and second means for unlocking and locking the lock is preferable because this allows the lock 20 to be operated from either side of the door 10. The knob 25 can be any type of graspable implement but is preferably one that is easy to grasp and turn. The knob 25 can be made of any suitably rigid material, including metal, metal alloy, plastic, and composite materials thereof. The lock 20 is positioned at an adequate distance 22 from the ground such that a small child cannot reach the lock 20. An adequate distance 22 from the ground is at least about 1.5 meters (e.g., 1.4, 1.45, 1.5, 1.55, 1.6, 1.65, 1.7, 1.75, 1.8, 1.83, 1.9, 2.0, 2.1, 2.2 meters).

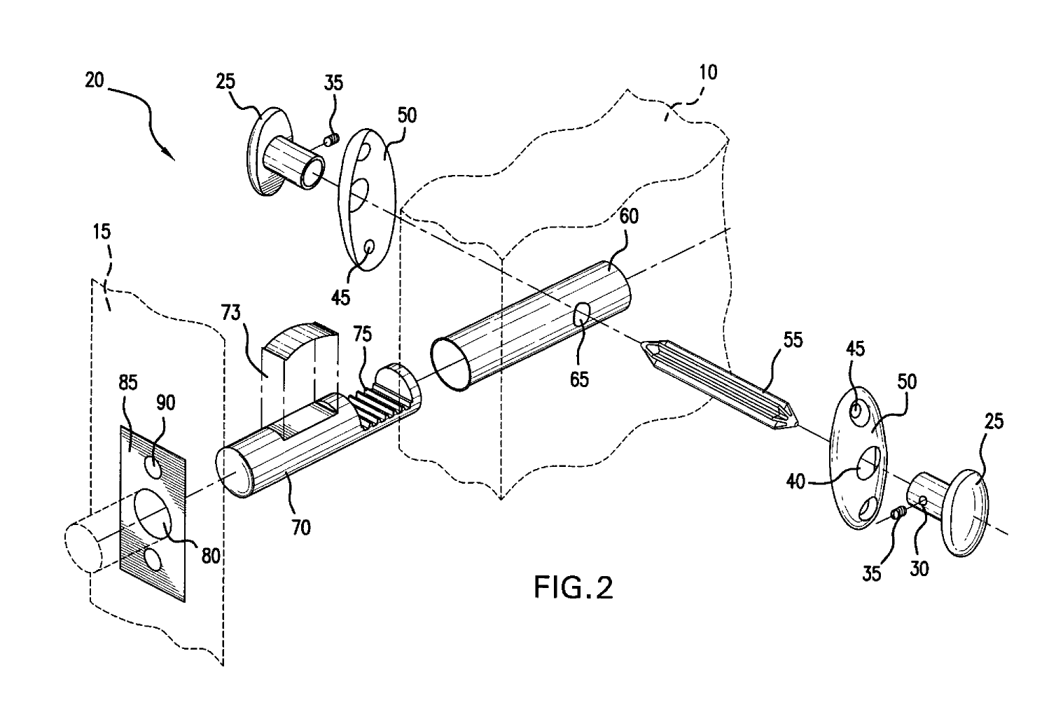

As shown in FIG. 2, one embodiment of a keyless lock 20 includes several components for mounting and operating the lock 20. Mounted inside the door 10 is a locking bolt housing 60 having an aperture 65 for receiving a connecting means 55. A locking bolt 70 is disposed within the locking bolt housing 60 when the lock 20 is in a locked position but moves at least partially out of the locking bolt housing 60 when the lock 20 is in a locked position. The locking bolt 70 is moved in and out of the locking bolt housing 60 via a connecting means 55 and a knob 25. The locking bolt 70 and knob 25 are operably connected by the connecting means 55. In this embodiment, the connecting means 55 is shown as a ribbed connecting rod 55. Any suitable device or component for operably connecting the knob 25 to the locking bolt 70, however, can be used. The connecting rod 55 has a first end that is attached to the knob 25 and a second end that protrudes through the aperture 65 in the locking bolt housing 60. In the embodiment shown in FIG. 2, the knob 25 is attached to the first end of the connecting rod 55 by screws 35 that are screwed into screw holes 30 of the knob 25. A decorative plate 50 is preferably installed between the connecting rod 55 and the knob 25 in order to conceal any hole made in the door 10 by the installation of the connecting rod 55. The decorative plate 50 has a central aperture 40 through which the first end of the connecting rod 55 is disposed so that it can be attached to the knob 25. The decorative plate 50 can be attached to the door 10 by any suitable means but in the embodiment shown in FIG. 2, the plate 50 is attached to the door 10 via two screw holes 45 and screws that are driven therethrough.

The locking bolt 70 shown in FIG. 2 has a cavity at one end which features a series of teeth 75 for engaging the ribbed connecting rod 55. The locking bolt 70 also includes a chamber housing a spring 73 that is positioned mostly interior to the chamber when the locking bolt 70 is positioned within the locking bolt housing 60 but that is urged out of the chamber when the locking bolt 70 is moved from the locking bolt housing 60. When the locking bolt 70 is disposed within the locking bolt housing 60, the spring 73 is positioned slightly out of the chamber and contacting the interior wall of the locking bolt housing 60 such that the spring 73 seats the locking bolt 70 firmly within the locking bolt housing 60.

When the locking bolt 70 is moved from inside the locking bolt housing 60 it moves towards the portion of the door frame 15 (or door jamb or wall) that is disposed opposite to the keyless lock 20. A mounting plate 85 having a central bore 80 therein is rigidly mounted to this portion of the door frame 15 (or door jamb or wall) for receiving the locking bolt 70. The mounting plate 85 is rigidly mounted to the door frame 15 (or door jamb or wall) via any suitable mounting means (e.g., screw holes 90 and screws driven therethrough).

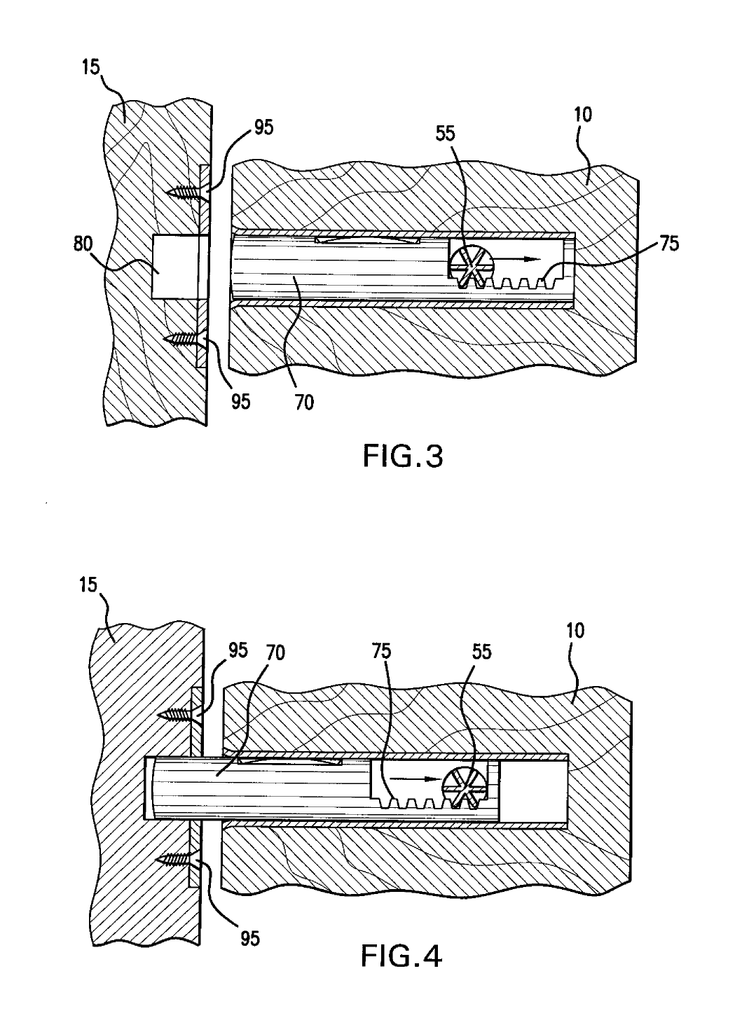

The mechanism by which the keyless lock 20 of FIGS. 1 and 2 operates is illustrated in the cross-sectional views of FIGS. 3 and 4. FIG. 3 illustrates a keyless lock 20 in an unlocked position in which the locking bolt 70 is disposed entirely within the locking bolt housing 60. The second end of the connecting rod 55 is shown positioned within the locking bolt 70 cavity having a series of teeth 75. The ribs of the ribbed connecting rod 55 mate with the spaces between the teeth 75, thereby forming a gear in which the movement of the locking bolt 70 is caused by rotating the ribbed connecting rod 55. The connecting rod 55 is rotated via manipulation of the knob 25, i.e., turning the knob from a resting position. When the connecting rod 55 is rotated in the direction of the arrow in FIG. 3, the ribs of the connecting rod 55 grip the teeth 75 of the locking bolt 70 and the connecting rod 55 moves in the direction of the arrow while it urges the locking bolt 70 out of the locking bolt housing 60. As the locking bolt 70 is urged from the locking bolt housing 60, the locking bolt 70 is urged into the central bore 80 of the mounting plate 85 (FIG. 4), thereby locking the door. To unlock the door, the connecting rod 55 is rotated in the opposite direction and the movement of the locking bolt 70 is reversed, disposing the locking bolt 70 within the locking bolt housing 60. In addition to the dead bolt-type lock described above, any bolt mechanism (e.g., spring-loaded or other mechanism) can be used in a keyless lock of the invention. In addition to the mounting plate for receiving the locking bolt described above, a keyless lock of the invention can be mounted to a door, door frame, or door jamb by any suitable mounting means.

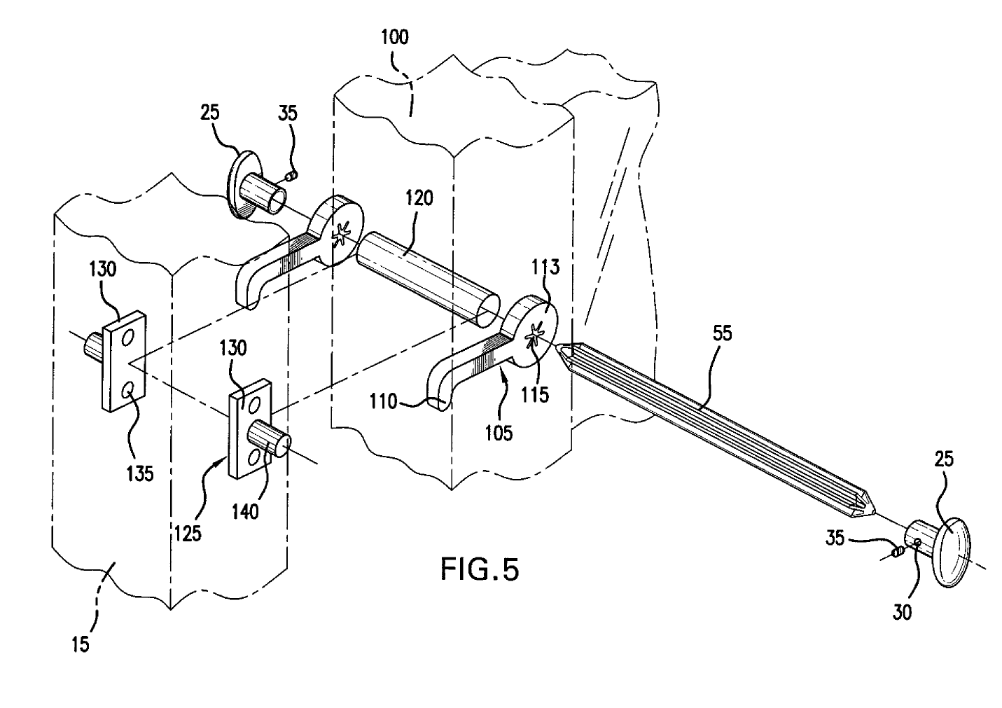

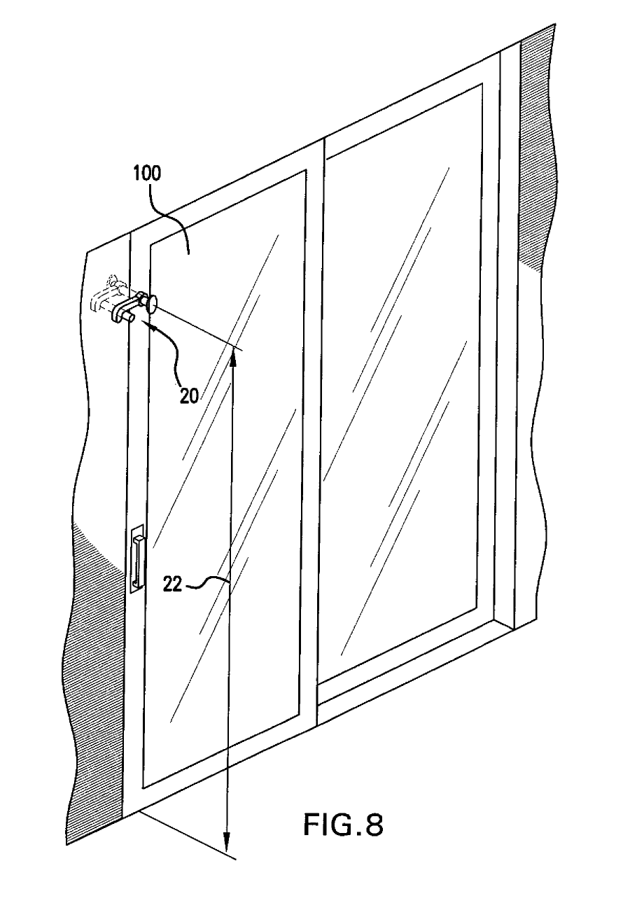

Another exemplary embodiment of a keyless lock 20 is shown in FIG. 5. The keyless lock 20 of FIG. 5 is preferred for use with a sliding door, including, for example, sliding glass doors that are often found at the rear side of houses having swimming pools. The keyless lock 20 is shown mounted in a sliding door 100 in FIG. 8. In this embodiment, the keyless lock 20 includes a housing 120 mounted within the door 100. The housing 120 is operably connected to a latching means 105 having a body 113, an aperture 115 having multiple grooves, the aperture 115 central to the body 113, and a hook-shaped arm 110 via a connecting means 55. The latching means 113 is rotated back and forth between a locked position and an unlocked position via a knob 25 and the connecting means 55. In this embodiment, the connecting means 55 is shown as a ribbed connecting rod 55. Any suitable device or component for connecting the knob 25 to the latching means 105, however, can be used. The connecting rod 55 has a first end that is attached to the knob 25 and a second end that protrudes through the multi-grooved aperture 115 of the latching means 105 and into the housing 120. The knob 25 is attached to the first end of the connecting rod 55 by any suitable means (e.g., screws 35 that are screwed into screw holes 30 of the knob 25).

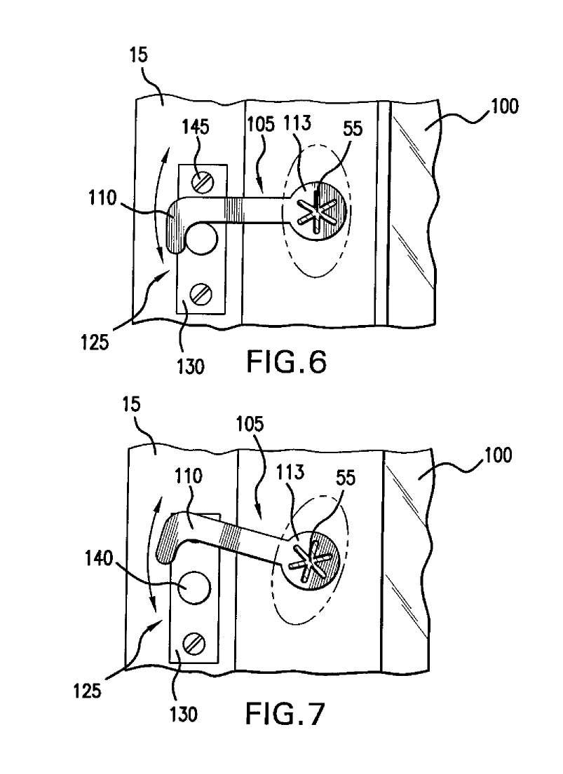

The keyless lock 20 shown in FIG. 6 also has a securing means 125 having a body 130 and a member 140 extending from the body 130 for securing the hook-shaped arm 110 of the latching means 105. The securing means 125 is rigidly mounted to the appropriate portion of the door frame 15 (or door jamb or wall) disposed opposite to the keyless lock. The securing means 125 is rigidly mounted to the door frame 15 (or door jamb or wall) via any suitable means (e.g., screw holes 135 and screws 145 driven therethrough). The lock 20 is positioned at an adequate distance 22 from the ground (e.g., 1.5 meters) such that a small child cannot reach the lock 20. The lock 20 can include one means for locking and unlocking the lock (e.g., knob 25) mounted to one side of the door 10, but preferably includes a first and a second means for unlocking the lock (e.g., two knobs 25), the first means mounted to the interior surface of the door and the second means mounted to the exterior surface of the door 10. Having first and second means for unlocking and locking the lock is preferable because this allows the lock 20 to be operated from either side of the door 10. The knob 25 can be any type of graspable implement but is preferably one that is easy to grasp and turn. The knob 25 can be made of any suitably rigid material, including metal, metal alloy, plastic, and composite materials thereof.

Operation of the keyless lock 20 shown in FIGS. 5 and 8 is illustrated in FIGS. 6 and 7. FIG. 6 illustrates a keyless lock 20 in a locked position in which the hook-shaped arm 110 of the latching means 105 is disposed on the member 140 extending from the body 130 of the securing means 125. The first end of the connecting rod 55 is shown positioned within the multi-grooved aperture 115 central to the body 113 of the latching means 105. In this embodiment, the ribs of the ribbed connecting rod 55 mate with the grooves of the aperture 115, thereby forming a gear in which the rotation of the latching means 105 is coupled to the rotation of the ribbed connecting rod 55. The connecting rod 55 and latching means 105 are rotated via manipulation of the knob 25, i.e., turning the knob from a resting position. When the connecting rod 55 is rotated clockwise, the ribs of the connecting rod 55 catch in the grooves of the aperture 115 of the body 113 of the latching means 105 and lift the hook-shaped arm 110 away from the member 140 (FIG. 7) so that the hook-shaped arm 110 is no longer secured to the securing means 125, thereby unlocking the door. To lock the door, the knob 25 is rotated in a counter-clockwise direction, thereby securing the hook-shaped arm 110 to the member 140 extending from the body 130 of the securing means 125.

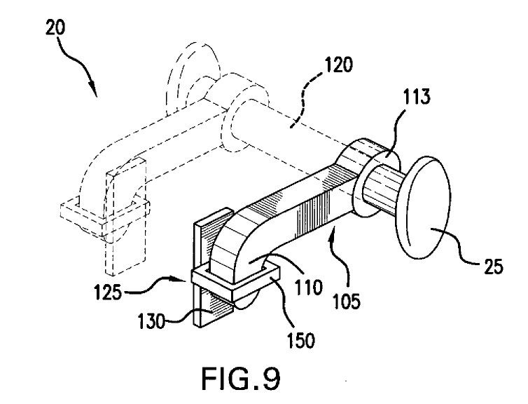

A variation of the keyless lock of FIGS. 5-8 is illustrated in FIG. 9. In this embodiment, the keyless lock 20 includes a housing 120 mounted within a door. The housing 120 is operably connected to a knob 25 and a latching means 105 having a body 113 with a central aperture 115, and a hook-shaped arm 110. A portion of the knob 25 is passed through the aperture of the latching means 105 and protrudes into the housing 120. The knob 25, latching means 105, and housing 120 are all securely connected such that rotating the knob 25 also rotates the latching means 105 and the housing 120. The keyless lock 20 shown in FIG. 9 also has a securing means 125 having a body 130 and a member 150 extending from the body 130 for receiving the arm 110 of the latching means 105. The securing means 125 is rigidly mounted to a portion of the door frame (or door jamb or wall) disposed at essentially the same distance from the ground as the knob 25. The securing means 125 is rigidly mounted to the door frame (or door jamb or wall) by any suitable means. The latching means 105 is rotated back and forth between a locked position and an unlocked position via turning of the knob 25. By rotating the knob 25 such that the arm 110 of the latching means 105 is disposed within the 150 member for receiving the arm 110 of the latching means 105, the lock 20 is engaged and the door cannot be opened.

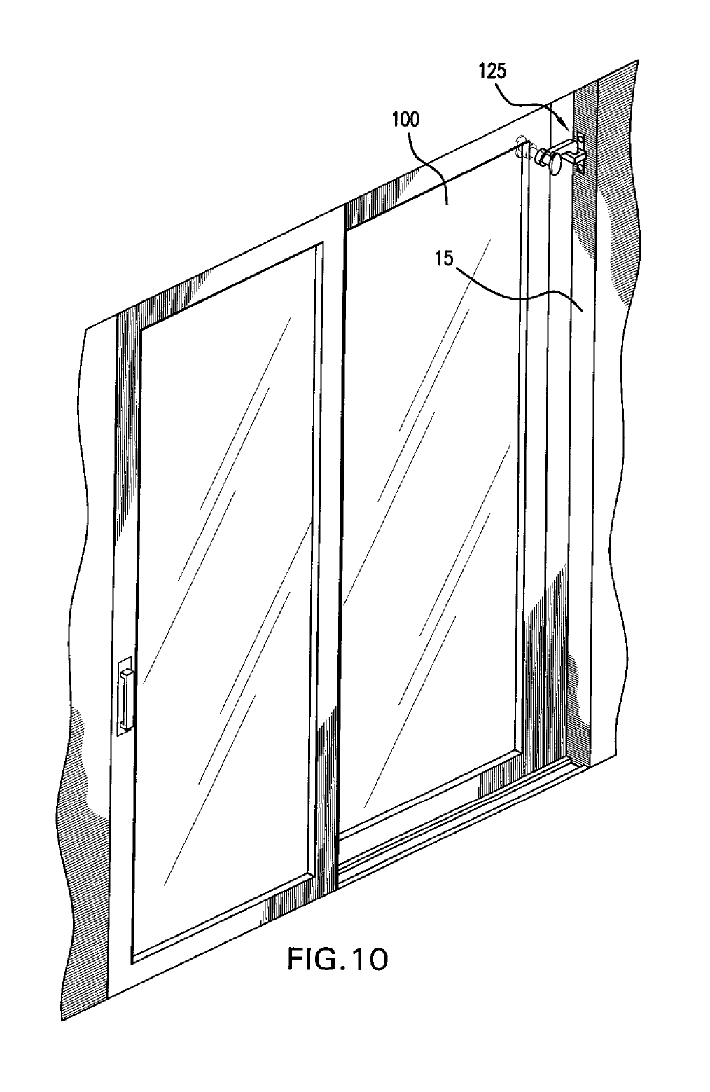

FIG. 10 illustrates another embodiment of the keyless lock 20 of FIG. 9 mounted in a sliding door 100. In this embodiment, the securing means 125 is rigidly mounted to the portion of the door frame 15 (or door jamb) as shown.

A keyless lock of the invention is used to lock a door without requiring a key and without allowing small children to operate the lock. The invention thus provides a kit and a method for locking a door. An exemplary kit of the invention includes a first means for locking and unlocking the lock and a second means for locking and unlocking the lock that when installed in the door, the first means is positioned on the interior surface of the door and the second means is positioned on the exterior surface of the door. The kit also includes printed instructions for installing the keyless lock in the door at a distance from the bottom of the door of at least about 1.5 meters. An exemplary method of locking a door includes the steps of: (a) providing a door, (b) providing a keyless lock installed within the door, the keyless lock comprising a first means for locking and unlocking the lock and a second means for locking and unlocking the lock, the first means positioned on the interior surface of the door and the second means positioned on the exterior surface of the door, and (c) manipulating the first or the second means for locking and unlocking the lock.

From the foregoing, it can be appreciated that the keyless lock of the invention provides a system for preventing young children from opening doors while providing unfettered access to older children and adults. While the above specification contains many specifics, these should not be construed as limitations on the scope of the invention, but rather as examples of preferred embodiments thereof. Many other variations are possible. For example, the means for locking and unlocking the lock can be any suitable device in addition to a knob, including a handle or other graspable implement. As other examples, the knob may have a different shape, the connecting means can have a different shape, the locking bolt may have a different means for engaging the connecting means, and the spring may have a range of tensions. Different movements may be required to engage the means for locking and unlocking the lock (e.g., knob) and different movements of the means for locking and unlocking the lock (e.g., knob) may be required to cause the retraction of the locking bolt. Also, different securing and mounting arrangements can be used. Different techniques may be used to connect various components to one another. Such techniques may include, for example, molding, welding, use of adhesives, and press fitting. Furthermore, the general shapes and relative sizes of the various components may vary. Many different materials may be considered suitable for manufacturing the components described herein.

Accordingly, the scope of the invention should be determined not by the embodiments illustrated, but by the appended claims and their legal equivalents.

What is claimed is:

1. A door with a keyless lock, the keyless lock being positioned on the door at a height at least about 1.5 meters from the bottom of the door and comprising: a first knob for locking and unlocking the lock and a second knob for locking and unlocking the lock, and a device for reversibly securing the door to a door frame, wherein the first knob and the second knob are operatively connected to the device, and the first and second knobs are each reversibly positionable between a locked position that causes the device to secure the door to the door frame and an unlocked position that causes the device to not secure the door to the doorframe, and wherein either the first or the second knob must be manually positioned in the locked position in order to secure the door to the door frame.

2. The door of claim 1, wherein the door is a hinged door and the keyless lock consists essentially of the first knob, the second knob, and the device that reversibly secures the door to a door frame, and the device consists essentially of a locking bolt disposed within a locking bolt housing, a connecting rod having a first portion attached to the first knob, a second portion attached to the second knob, and a third portion attached to the locking bolt, wherein the locking bolt is movable within the locking bolt housing by moving either the first or the second knob.

3. The door of claim 2, wherein the connecting rod comprises a ribbed portion.

4. The door of claim 1, wherein the door is a sliding door and the keyless lock consists essentially of the first knob, the second knob, and the device that reversibly secures the door to a door frame, and the device consists essentially of a latch, a connecting rod having a first portion attached to the first knob, a second portion attached to the second knob, and a third portion attached to the latch, wherein the latch is movable by moving either the first or the second knob.

5. The door of claim 4, wherein the latch comprises a hook-shaped arm.

6. The door of claim 4, wherein the latch comprises two hook-shaped arms.

7. The door of claim 4, wherein the connecting rod comprises a ribbed portion.

8. The door of claim 1, wherein the first and second knobs are rotatably mounted to the lock.
